(19) United States
(12) Patent Application Publication
(10) Pub. No.: US 2020/0098488 A1
(43) Pub. Date: Mar. 26, 2020

(54) FORMULATION OF MATERIAL FOR INSULATING WIRE AND PRODUCT PRODUCED THEREFROM

(71) Applicant: CABOPOL - POLYMER COMPOUNDS, S.A., Porto De Mós (PT)

(72) Inventors: Rita Alexandra ASCENSO MENESES SALVADA, Porto De Mós (PT); Joaquim Fernando MORais da CRUS, Porto De Mós (PT); Tiago José GARRIDO DA COSTA, Porto De Mós (PT)

(21) Appl. No.: 16/484,567

(22) PCT Filed: Feb. 9, 2018
(86) PCT No.: PCT/IB2018/050811

§ 371 Date: Aug. 8, 2019

(30) Foreign Application Priority Data
Feb. 9, 2017 (PT) 109905

(51) Int. Cl. H01B 3/44; C08L 23/06; C08L 25/06; C08K 3/013; C08K 3/22; C08K 3/30; C08K 5/5425; C08K 5/14; C08K 5/00; C08K 5/134; C08K 5/36; C08K 5/52; C08K 5/3437

(52) U.S. Cl. CPC H01B 3/441; C08L 2201/02; C08L 25/06; C08K 3/013; C08K 3/22; C08K 3/30; C08K 5/5425; C08K 5/14; C08K 5/005; C08K 5/1345; C08K 5/36; C08K 5/52; C08K 5/3437; C08L 2203/202; C08L 2207/04; C08L 2312/06; C08K 2003/2224; C08K 2003/2227; C08K 2003/2206; C08K 2003/3045; C08L 23/06

(57) ABSTRACT

This invention falls within the scope of insulation materials, more specifically compounds aimed at insulating wires used in cars. It consists of a formulation comprising 10%-50% by mass of a polyethylene or polyethylene copolymers-based resin, 5%-20% by mass of a Thermoplastic Elastomer-based resin and 3%-6% by mass of a primary antioxidant with phenolic and metal deactivation properties. This formulation allows a compound to be obtained with high thermal, chemical and mechanical resistance. According to an improved configuration, it further comprises 10%-55% by mass of a mineral filler with flame retardant properties, 1%-3% by mass of a thioester-based antioxidant, 1%-3% by mass of a phosphite-based antioxidant and 0.5%-2% by mass of a phosphate-based antioxidant. Additionally, a product which is obtained by mixing the said formulation and subsequent crosslinking is also the object of this invention.

### FIELD OF THE INVENTION

This invention falls within the scope of insulation materials, more specifically compounds aimed at insulating wires used in cars.

### BACKGROUND OF THE INVENTION

Already known in the state of the art is the use of polyolefin-based compounds which are crosslinked by electron beam processing (E-beam), steam vulcanization and moisture cure, having flame retardant properties, chemical resistance and thermal resistance in compliance with the standard ISO 6722.

The patent application published under the number US2015248948A1 discloses a formulation according to the standard ISO 6722, which is comprised of a resin with polyethylene or derivatives thereof, using magnesium hydroxide treated with vinyl silane, as well as a mixture of two antioxidants, one primary and another secondary, the said patent relating to a process of moisture crosslinking which uses a catalyst as initiator.

The patent application published under the number EP1092752A2 discloses a halogenated system, based on ethylene copolymers, wherein the crosslinking process is steam vulcanization, the base ethylene copolymer is Ethylene Vinyl Acetate and the fire-resistant loads are bromine and antimony trioxide.

The solutions known in the state of the art are not satisfactory in what concerns thermal, chemical and mechanical resistance.

### SUMMARY OF THE INVENTION

It is therefore the object of this invention a formulation intended for obtaining wire insulation material which comprises:

a. 10% to 50% by mass of a polyethylene or polyethylene copolymers-based resin;
b. 5% to 20% by mass of a Thermoplastic Elastomer-based (TPE) resin;
c. 3% to 6% by mass of a primary antioxidant with phenolic and metal deactivation properties.

The formulation according to this invention is suitable for the production of an insulation material by means of crosslinking. The said formulation allows a compound to be obtained with high thermal, chemical and mechanical resistance, thus significantly improving the thermal resistance of class “D” compounds, in compliance with the standard ISO 6772.

This formulation allows a crosslinked product to be obtained, which is aimed at insulating wires for the automotive industry, with improved features in what concerns the mechanical, thermal and chemical resistance, as well as the flame retardancy, comparatively to the ones already known in the state of the art.

In an advantageous embodiment of this invention, it further comprises 0.1% to 4% by mass of Calcium Oxide and 0.1% to 5% by mass of Zinc Sulphate. The inclusion of this compound, combined with the aforementioned primary antioxidant, allows:

a more stable extrusion to be promoted;
a better resistance to oxidation of copper (in the stage of wiring, comprising the product obtained from the formulation of this invention and the copper wire), thus stabilizing the compound when in contact with the copper insulation;
an increased processing speed;
pre-crosslinking problems to be avoided in case the process used is steam vulcanization.

In an advantageous embodiment of the formulation of this invention, it additionally comprises:

10% to 55% by mass of a mineral filler with flame retardant properties;

1% to 3% by mass of a thioester-based antioxidant;

1% to 3% by mass of a phosphite-based antioxidant;

0.5% to 2% by mass of a phosphate-based antioxidant.

The antioxidants combination of this embodiment of the invention is related to an improved thermal resistance, wherein the proportion is an important aspect, since the said antioxidants are partially consumed during the crosslinking process to be performed, thus affecting the crosslinked percentage in a product obtained therefrom.

In an advantageous embodiment of this invention, it further comprises 1% to 2% by mass of an organosilane. This allows a bonding of the polymeric matrix to the mineral fillers to occur, thus creating a structure which provides the compound with improved properties as regards Elongation and Tensile Strength. This advantage is obtained with better results when the organosilane is vinyltrimethoxysilane or vinyltriethoxysilane.

In another advantageous embodiment of the formulation of this invention, which is susceptible of being combined with any of the above described ones, the mineral filler has flame retardant properties and consists of one or more combined inorganic components, preferably comprising Magnesium Hydroxide, thus enabling a better performance, due to the extrusion temperatures required to this type of compound, in as much as it allows higher temperatures to be used comparatively to the ones of the state of the art (within the range of 180-210 ° C.) which then potentiates the output and finishing of the material.

It is also an object of this invention to provide a product which is obtained from:

a. mixing the components of the formulation according to any of the above described embodiments;
b. crosslinking by means of a crosslinking agent or by electron beam processing.

This product has the aforementioned advantages, thanks to the formulation of this invention being crosslinked. The crosslinking agent allows radicals to be formed in the polymeric matrix in such a way that a bond is created between the said matrix and the organosilane, also enabling the compound to be crosslinked.

In the best embodiment of the product of this invention, it is obtained by crosslinking with a crosslinking agent, which consists of organic peroxide in 0.1% to 2% by mass relative to the mass of the said formulation, or by electron beam processing (E-beam).

### DETAILED DESCRIPTION OF THE INVENTION

The following combinations of the different antioxidants of the formulation according to this invention are the best embodiments identified.

In a specific configuration of the formulation of this invention, the primary antioxidant is one of the following compounds: pentaerythrityl-tetrakis[3-(3,5-di-tert-butyl-4-hydroxyphenyl)-propionate], 2,2 [symbol] -thiodiethylbis-[3-(3,5-di-tert-butyl-4-hydroxyphenyl)-propionate], octadecyl-3-(3,5-di-tert-butyl-4-hydroxyphenyl)pro-pionate, 4,4 [symbol] -thiobis(6-tert-butyl-m-cresol), triethylene glycol-bis-3(3-tert-butyl-4-hydroxy-5-methyl phenyl)propionate, 4,4 [symbol] -thiobis[2-(1,1-dimethylethyl)-5-methyl-phenol, tetrakis[methylene(3,5-di-tert-butyl-4-hydroxy)cinnamate]methane and 2,2′-Oxamido bis-[ethyl-3-(3,5-di-t-butyl-4-hydroxyphenyl) propionate.

In a specific configuration of the formulation of this invention, the thioester-based antioxidant is dioctadecyl 3,3′-thiodipropionate.

In a specific configuration of the formulation of this invention, the phosphite-based antioxidant is one of the following compounds: tris(2,4-di-tert-butylphenyl)phosphite or Bis-(2, 4-di-t-butylphenol) Pentaerythritol Diphosphite.

In a specific configuration of the formulation of this invention, the phosphate-based antioxidant is 2,2,4-trimethyl-1,2-dihydroquinoline.

These different specific configurations of the formulation comprising different specific antioxidants offer the best performances as regards thermal resistance.

In another embodiment of this invention, the mineral filler with flame retardant properties is Aluminium Hydroxide.

In a preferable embodiment of the formulation of this invention, which is susceptible of being combined with any of the above, the mineral filler is included in 45% to 55% by mass.

In a preferable embodiment of the formulation of this invention, which is susceptible of being combined with any of the above, the polyethylene or polyethylene copolymers-based resin has a density of from 0.92 to 0.95 g/cm⁻³.

In a preferable embodiment of the formulation of this invention, which is susceptible of being combined with any of the above, the TPE comprises styrene.

In the best embodiments of the product of this invention, the said product being obtained by crosslinking by means of a crosslinking agent which consists of an organic peroxide, the crosslinking agent is specifically comprised of one of the following compounds: t-butyl cumyl peroxide, benzoyl peroxide, cumene hydro-peroxide, dicumyl peroxide, methyl ethyl ketone peroxide, 2,5-dimethyl-2,5-di(tert-butylperoxy)hexane, di-tert-butyl peroxide, t-butyl peroxybenzoate.

### EMBODIMENTS OF THE INVENTION

The following table shows 9 specific formulations according to this invention, all of them crosslinked with dicumyl peroxide, resulting in 9 products being obtained by mixing the components of the formulation and subsequent extrusion, after which the moulded plates were produced, the latter having been crosslinked by means of steam vulcanization or electron beam processing.

| Components % by mass | Formula (F) 1 | F2 | F3 | F4 | F5 | F6 | F7 | F8 |
|---|---|---|---|---|---|---|---|---|
| Polyethylene | 0 | 0 | 25 | 24 | 29 | 14 | 19 | 20 |
| Polyethylene Copolymer | 29 | 32 | 5 | 5 | 5 | 5 | 5 | 9 |
| TPE-S | 5 | 5 | 5 | 5 | 5 | 10 | 10 | 5 |
| Magnesium Hydroxide | 50 | 50 | 50 | 50 | 50 | 50 | 50 | 50 |
| Primary Antioxidant | 6 | 6 | 4 | 4 | 2 | 6 | 6 | 6 |
| Thioester Antioxidant | 2 | 2 | 4 | 3 | 1 | 2 | 2 | 2 |
| Phosphite Antioxidant | 1 | 1 | 1 | 2 | 1 | 1 | 1 | 1 |
| Phosphate Antioxidant | 0.5 | 0.5 | 0.5 | 0.5 | 0.5 | 0.5 | 0.5 | 0.5 |
| Organosilane | 1.5 | 1.5 | 1.5 | 1.5 | 1.5 | 1.5 | 1.5 | 1.5 |
| Peroxide | 1 | 1 | 1 | 1 | 1 | 1 | 1 | 0.2 |
| ZnS | 3 | 0 | 3 | 3 | 3 | 3 | 3 | 3 |
| CaO | 1 | 1 | 0 | 1 | 1 | 1 | 1 | 1 |

The formulae were produced and the crosslinked plates were tested according to the Standard ISO6722, with the following results being obtained:

| Trials | F1 | F2 | F3 | F4 | F5 | F6 | F7 | F8 |
|---|---|---|---|---|---|---|---|---|
| Density g/cm3 | 1.36 | 1.37 | 1.36 | 1.37 | 1.34 | 1.35 | 1.36 | 1.37 |
| Breaking Load MPa | 18 | 18.3 | 23.3 | 24.5 | 26.4 | 18.2 | 20.3 | 22.1 |
| Elongation % | 250 | 2350 | 205 | 198 | 190 | 300 | 270 | 210 |
| Flame retardancy | Pass | Pass | Pass | Pass | Pass | Pass | Pass | Pass |
| Winding to −40° C. for 4 h | Pass | Pass | Pass | Pass | Fail | Pass | Pass | Pass |
| OIT 240° C. min | 170 | 128 | 120 | 100 | 77 | 198 | 181 | 175 |
| Aging 175° C. 240 h | Pass | Fail | Pass | Pass | Fail | Pass | Pass | Pass |
| Aging 150° C. 3000 h | Pass | Fail | Fail | Fail | Fail | Pass | Pass | Pass |
| Aging 175° C. 360 h | Pass | Fail | Fail | Fail | Fail | Pass | Pass | Pass |
| Rheometry 30 min 150° C. 10 RPM | | | | | | | | |
| Tr (min) | 15:19 | 15:36 | 11:54 | 17:04 | 13:13 | 12:11 | 14:52 | 18:06 |
| Tv (min) | 02:16 | 02:07 | 02:43 | 03:33 | 02:45 | 04:47 | 01:23 | 04:33 |
| Tc (min) | 14:27 | 14:28 | 10:20 | 15:28 | 12:09 | 09:29 | 14:16 | 16:28 |
| Maximum Torque % | 26.5 | 27.9 | 55 | 30 | 39.1 | 28.1 | 29.9 | 30.3 |

The criterion used for the assessment of the aging trials was a minimum elongation of 50%, in order to ensure that the winding test referred to in the standard IS06722 is complied with. The Oxidative Induction Time (OIT) was used as a measure of the thermal resistance of the material when subjected to an oxygen atmosphere at a temperature of 240° C. All these tests were carried out while the material was in contact with a copper base, in order to assess the compound's resistance to oxidation under the action of copper. This OIT test makes it possible to determine if the formulation will have enough resistance to endure the test of the 3000 hours at 150° C. and it serves as an accelerated trial to the same, thus helping with obtaining a result within a short period of time.

Based upon these results, one verifies that, with this composition, the OIT values obtained are of around 190 min, which means a significant improvement in terms of thermal resistance comparatively to the values of the state of the art, which are typically lower than 150 min.

As demonstrated by the different formulations above described, this improvement arises from the presence of the TPE, the primary antioxidant and the Zinc Sulphate. In effect, it is an optimal formulation considering the different combinations disclosed by this invention.

A Brabender Rheometer with Roller blades was used to test the processability (maximum torque), and the reaction speed (Tr) and the cure rate (Tc) here illustrate the fact that the presence of Calcium Oxide allows for higher Tr and Tc when compared to a formulation without this additive, thus indicating a faster reaction, which can lead to the formation of gels and, consequently, problems in the crosslinking of the product. The maximum torque, which in this case is also higher, indicates a lower processability of this material. These results were confirmed in the tests performed in an extrusion line. Therefore, the said results lead us to conclude that the developed compounds represent an improvement and an advantage as regards the safety of the process, as well as its yield, thus allowing for an optimization of the resources when compared to the known state of the art.

As will appear evident to a person skilled in the art, this invention shall not be limited to the embodiments described in this document, with several modifications being feasible provided that they are kept within the scope of this invention.

1. A formulation for obtaining wire insulation material, characterized in that it comprises:
a. 10% to 50% by mass of a polyethylene and/or polyethylene copolymers-based resin;
b. 5% to 20% by mass of a Thermoplastic Elastomer-based (TPE) resin;
c. 3% to 6% by mass of a primary antioxidant with phenolic and metal deactivation properties.

2. A formulation according to claim 1, characterized in that it further comprises 0.1% to 4% by mass of Calcium Oxide and 0.1% to 5% by mass of Zinc Sulphate.

3. A formulation according to claim 1, characterized in that it additionally comprises:
10% to 55% by mass of a mineral filler with flame retardant properties;
1% to 3% by mass of a thioester-based antioxidant;
1% to 3% by mass of a phosphite-based antioxidant;
0.5% to 2% by mass of a phosphate-based antioxidant.

4. A formulation according claim 1, characterized in that it further comprises 1% to 2% by mass of an organosilane.

5. A formulation according to claim 1, characterized in that the organosilane is from the same family of vinyltrimethoxysilane and vinyltriethoxysilane.

6. A formulation according to claim 1, characterized in that the mineral filler has flame retardant properties and consists of one or more combined inorganic components.

7. A formulation according to claim 1, characterized in that the mineral filler with flame retardant properties is Magnesium Hydroxide.

8. A formulation according to claim 6, characterized in that the mineral filler with flame retardant properties is Aluminium Hydroxide.

9. A formulation according to claim 1, characterized in that the mineral filler is present in 45% to 55% by mass.

10. A formulation according to claim 1, characterized in that the polyethylene or polyethylene copolymers-based resin has a density of from 0.92 to 0.95 g/cm⁻³.

11. A formulation according to claim 1, characterized in that the TPE comprises styrene.

12. A formulation according to claim 1, characterized in that the primary antioxidant is selected from the following compounds:
pentaerythrityl-tetrakis [3 -(3, 5-di-tert-butyl-4-hydroxyphenyl)-propionate], 2,2′-thiodiethylbis-[3-(3,5-di-tert-butyl-4-hydroxyphenyl)-propionate], octadecyl-3 -(3, 5-di-tert-butyl-4-hydroxyphenyl)propionate, 4,4′-thiobis(6-tert-butyl-m-cresol), triethylene glycol-bis-3 (3 -tert-butyl-4-hydroxy-5-methyl phenyl)propionate, 4,4′-thiobis[2-(1,1-dimethylethyl)-5-methylphenol, tetrakis[methylene(3,5-di-tert-butyl-4-hydroxy)cinnamate]methane or 2,2′-Oxamido bis-[ethyl-3-(3,5-di-t-butyl-4-hydroxyphenyl) propionate.

13. A formulation according to claim 1, characterized in that the thioester-based antioxidant is dioctadecyl 3,3′-thiodipropionate.

14. A formulation according to claim 1, characterized in that the phosphite-based antioxidant is one of the following compounds: tris(2,4-di-tert-butylphenyl)phosphite, Bis-(2,4-di-t-butylphenol) Pentaerythritol Diphosphite.

15. A formulation according to claim 1, characterized in that the phosphate-based antioxidant is 2,2,4-trimethyl-1,2-dihydroquinoline.

16. A product for obtaining wire insulation material, characterized in that the said material is obtained by:
a. mixing the components of the formulation according to any of the previous claims;
b. crosslinking by means of a crosslinking agent or by electron beam processing.

17. A product according to claim 1, characterized in that the crosslinking agent is organic peroxide in 0.1% to 2% by mass relative to the mass of the said formulation.

18. A product according to claim 1, characterized in that the crosslinking agent is selected from the group of t-butyl cumyl peroxide, benzoyl peroxide, cumene hydroperoxide, dicumyl peroxide, methyl ethyl ketone peroxide, 2,5-dimethyl-2,5-di(tert-butylperoxy)hexane, di-tert-butyl peroxide, t-butyl peroxybenzoate.

19. A product according to claim 16, characterized in that, between the steps a) and b), the formulation is extruded and moulded, thus resulting in one or more moulded plates.
